(19) United States
(12) Patent Application Publication
(10) Pub. No.: US 2024/0388990 A1
(43) Pub. Date: Nov. 21, 2024

(54) CLIENT POSITION AND MOTION REPORTS FOR EFFICIENT ROAMING

(71) Applicant: Cisco Technology, Inc., San Jose, CA (US)

(72) Inventors: Federico LOVISON, Fontanelle (IT); Sukrit DASGUPTA, Norfolk, MA (US); Jerome HENRY, Pittsboro, NC (US); Juan Carlos ZUNIGA, Montreal (CA)

(21) Appl. No.: 18/665,363

(22) Filed: May 15, 2024

Related U.S. Application Data
(60) Provisional application No. 63/502,597, filed on May 16, 2023.

(51) Int. Cl. H04W 40/12; H04W 40/02; H04W 64/00

(52) U.S. Cl. CPC H04W 40/12; H04W 40/026; H04W 64/006

(57) ABSTRACT

The present disclosure provides techniques for optimizing roaming by using client location and motion state data. An access point (AP) receives contextual data transmitted from a client device associated with the AP. The AP analyzes the contextual data to determine at least one of a current location of the client device or one or more movement characteristics of the client device. The AP identifies one or more target APs, from a plurality of neighboring APs, for the client device to roam to. The AP sends a roaming recommendation to the client device including the one or more target APs.

### CROSS-REFERENCE TO RELATED APPLICATIONS

This application claims benefit of co-pending U.S. provisional patent application Ser. No. 63/502,597 filed May 16, 2023. The aforementioned related patent application is herein incorporated by reference in its entirety.

### TECHNICAL FIELD

Embodiments presented in this disclosure generally relate to wireless communication. More specifically, embodiments disclosed herein relate to improving wireless roaming with client location and motion state data.

### BACKGROUND

Conventionally, the strategy for roaming recommendations by access point (APs) for mobile devices, such as smartphones and laptops, have been based primarily on Radio Frequency (RF) metrics. Following standards like IEEE 802.11, these RF metrics focus on signal strength, signal-to-noise ratio (SNR), and the overall quality of the connection to the currently associated AP. When a device detects that the signal strength of its current connection falls below a defined threshold, it begins scanning for other alternative APs with stronger signals. Therefore, the decision to roam is mostly determined by these RF metrics, with the goal of maintaining a stable and robust connection by switching the device to an AP with better signal quality. However, while this conventional approach is effective at maintaining connectivity, it overlooks contextual factors, such as the device's location (or position) and motion state. Such a lack of consideration can lead to suboptimal roaming performance, resulting in a poor user experience.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment where a client device roams across two access points (APs) based on horizontal movements, according to some embodiments of the present disclosure.

FIG. 2 depicts an example environment where a client device roams across access points (APs) based on vertical movements, according to some embodiments of the present disclosure.

FIG. 3 depicts an example process of roaming optimization with location and motion state data, according to some embodiments of the present disclosure.

FIG. 4 depicts an example method of an AP optimizing roaming recommendations for its associated client device based on location and motion state data, according to some embodiments of the present disclosure.

FIG. 5 depicts an example method of a client device collecting location and motion state data and engaging with its associated AP to optimize roaming decisions, according to some embodiments of the present disclosure.

FIG. 6 is a flow diagram depicting an example method for optimizing roaming strategies with location and motion state data, according to some embodiments of the present disclosure.

FIG. 7 depicts an example AP supporting roaming optimization based on location and motion state data, according to some embodiments of the present disclosure.

FIG. 8 depicts an example client device supporting location and motion state data collection and roaming optimization, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by an access point (AP), contextual data transmitted from a client device associated with the AP, analyzing the contextual data to determine at least one of a current location of the client device or one or more movement characteristics of the client device, identifying one or more target APs, from a plurality of neighboring APs, for the client device to roam to, and sending a roaming recommendation to the client device including the one or more target APs.

Other embodiments in this disclosure provide one or more non-transitory computer-readable media containing, in any combination, computer program code that, when executed by operation of a computer system, performs operations in accordance with one or more of the above methods, as well as systems comprising one or more computer processors and one or more memories collectively containing one or more programs, which, when executed by the one or more computer processors, perform operations in accordance with one or more of the above methods.

### EXAMPLE EMBODIMENTS

The present disclosure provides techniques for improving wireless roaming for a client device based on its reported location and motion state data.

Conventionally, roaming recommendations by an AP for its associated client device have been primarily (or entirely) based on RF metrics. These RF metrics include signal strength (e.g., received signal strength indicator (RSSI)), SNR, or the overall quality of the transmission (e.g., a decrease in Modulation Coding Scheme (MCS) value or an increase in retry count), without considering the client device's current location and movements (such as whether it is moving, its speed, and direction).

Failure to consider location and motion state data may lead to a suboptimal roaming decision, especially when the client device's movement involves crossing multiple APs' coverage areas with varying signal strength and environmental characteristics. For example, when a client device moves away from its associated AP at a rapid speed and in a straight path away from the AP, the traditional method, relying solely on signal strength, may result in the AP attempting to maintain the connection as long as possible until the signal strength becomes too weak. The delay in initiating the roaming process could lead to a temporary loss of connectivity or degraded performance as the device switches to another AP. Another situation involves a client device moving away from its associated AP but at a slow speed, with the direction of movement frequently changing (indicating the device is not moving in a straight path away from the AP or may even be following a loop path). In such configurations, the conventional method, without considering location and movement data, may still prompt a roaming decision based solely on weakening RF signal strength. This may unnecessarily trigger the device to switch or roam to another AP, especially if the device was ultimately going to move back into a better coverage area of the original AP. The unnecessary roaming may disrupt current network service, leading to a reduced user experience.

Embodiments of the present disclosure introduce mechanisms or systems that enable an AP to consider the client device's location and movement when conducting roaming analysis and recommendations among a plurality of neighboring APs. Through the analysis of location and movement data, the AP may determine which neighboring APs are in the direction of the client device's movement. Based on the understanding, the AP may provide more accurate roaming recommendations, guiding the client device towards the most suitable AP to ensure a smooth roaming experience. This approach may reduce the likelihood of connection drops, minimize latency, and optimize network bandwidth utilization. In some embodiments, the optimized roaming recommendation mechanisms may enable the AP to correlate roaming events with the client device's vertical motions. By analyzing the vertical motion data of the client device, the AP may anticipate and facilitate inter-floor roaming, to ensure that connectivity is maintained seamlessly across different floors.

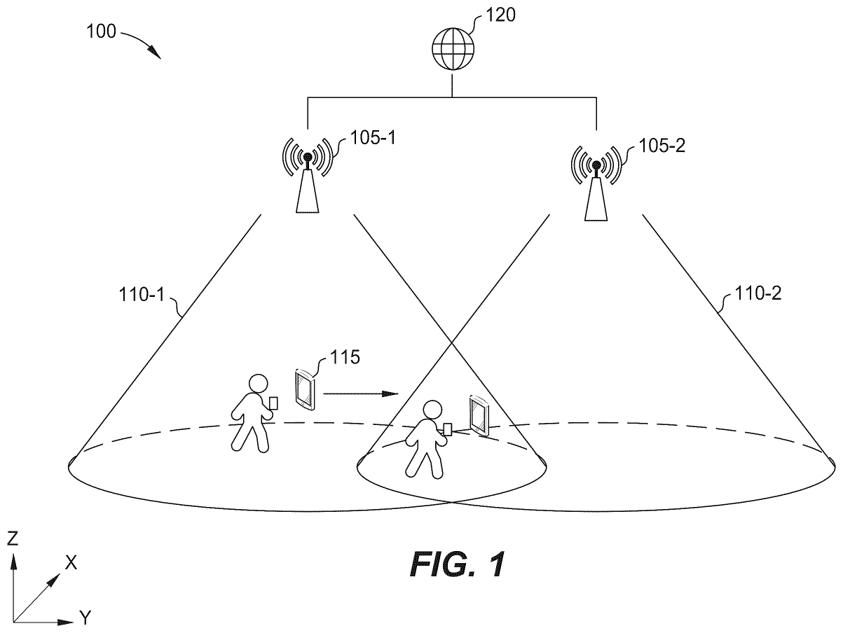

FIG. 1 depicts an example environment 100 where a client device roams across two access points (APs) based on horizontal movements, according to some embodiments of the present disclosure.

In the illustrated environment 100, two APs 105-1 and 105-2 are connected to the network 120. AP 105-1 provides signal coverage in area 110-1, and AP 105-2 provides signal coverage in area 110-2. The client device, STA 115, is currently associated with AP 105-1. During or after the association, in some embodiments, STA 115 may send a beacon report to AP 105-1 following the IEEE 802.11k standard, allowing AP 105-1 to be aware of other APs that STA 115 detected before joining the Basic Service Set (BSS) of AP 105-1. In the illustrated environment 100, the other APs that STA 115 heard may include AP 105-2. In some embodiments, based on the beacon report, AP 105-1 may predict the approximate location of STA 115, using methods such as quadrant determination or more precise positioning techniques. In some embodiments, the estimation of STA's 115 location may be enhanced through the use of trained machine learning (ML) models.

In FIG. 1, the user is depicted walking horizontally from the coverage area 110-1, served by AP 105-1, into the coverage area 110-2, served by AP 105-2. As the user moves into the coverage area 110-2, AP 105-1 detects a weakening in the signal strength (e.g., RSSI) from STA 115. In some embodiments, AP 105-1 may also observe a degradation in the STA's transmission quality (indicated by a decrease in the Modulation and Coding Scheme (MCS) value or an increase in the retry count transmissions). When these detected variables, such as RSSI, MCS values, or retry counts, meet defined criteria (e.g., RSSI falling below a defined threshold or retry counts exceeding a defined threshold), AP 105-1 concludes that STA 115 is moving away from its coverage area 110-1, and may be better served to maintain connectivity by roaming to another AP, such as AP 105-2.

In making the roaming recommendations, the conventional approach, following existing standards like 802.11k, involves AP 105-1 predicting the best neighboring AP for STA 115 to roam to based on various RF metrics, such as signal strength, channel utilization, and the load of each neighboring AP. AP 105-1 then consolidates the prediction and a list of neighboring APs (along with their RF metrics) within a neighbor report sent to STA 115.

Different from the conventional approach, AP 105-1 in the present disclosure is capable of making the roam recommendations (including the decision of whether to roam and/or prediction of the optimal timing and target AP to roam to) by considering STA's 115 location and movement data (real-time or historical). During or after association, AP 105-1 may send a message indicating to STA 115 that it can provide better roaming prediction if it has additional information about STA's 115 location and movement. In some embodiments, the message may be included within a specific frame, like a management frame. In some embodiments, the message may be communicated to the STA 115 as a simple bit set in an information element that is part of standard communication protocols between APs and client devices, such as beacon frames or probe responses.

STA 115, upon learning the AP's capability, may report its location and motion state data using a management frame. The reporting may be conducted periodically or triggered by specific events (such as the RSSI falling below a defined threshold). In some embodiments, the location data communicated by STA 115 may detail the device's precise or approximate geographical position, using coordinates or a reference to known network landmarks. The location data may be detected by the STA's 115 built-in hardware sensors, such as GPS for outdoor positioning. For indoor positioning, in some embodiments, the location data may be determined by using Bluetooth low energy (BLE) beacons, which provide location signals that STA 115 can use to triangulate its position within a structure, or the Fine Timing Management (FTM) protocol (which is included in 802.11az standard, 802.11-2016 standard, or 802.11bk standard) that enables STA 115 to measure the time of flight of Wi-Fi signals to accurately calculate its position relative to its associate AP 105-1.

In some embodiments, the motion state data may include a range of parameters that reflect the STA's movement patterns, including but not limited to, STA's 115 direction of travel, speed, and acceleration, among others. The motion state data may be detected utilizing some built-in hardware sensors, such as a compass for detecting direction, and an accelerometer for detecting changes in velocity.

With access to both location and motion state data (real-time or historical), AP 105-1 may determine the movement patterns of STA 115 with improved accuracy. AP 105-1 may then integrate STA's 115 movement patterns with RF metrics (e.g., RSSI, SNR) to determine whether roaming is useful for STA 115. In some embodiments, roaming may be considered useful for STA 115 when its movement patterns and the RF environment indicate that a switch to another AP would (or may) maintain or improve connectivity. For example, roaming may be useful when STA 115 is moving directly away from AP 105-1 towards AP 105-2 at a high speed, suggesting it will imminently exit the signal coverage 110-1 and enter the signal coverage 110-2. This movement pattern indicates that STA's 115 connection to AP 105-1 will weaken significantly, and therefore a switch to AP 105-2 is preferable to sustain a robust network connection.

In some embodiments, roaming may not be advisable in situations where STA 115 is moving at a low speed and the motion state data indicates it is moving in a loop, such as moving within a confined area within the coverage of AP 105-1. In such a configuration, even if STA 115 temporarily weakens its signal connection to AP 105-1, the benefit of roaming to another AP may be negligible benefits or even disruptive since STA 115 will shortly return to the coverage area of AP 105-1.

In some embodiments, when roaming is considered useful, AP 105-1 may evaluate which neighboring AP would provide the most suitable connectivity experience for STA 115. In the illustrated environment 100, with only one neighboring AP (e.g., AP 105-2), AP 105-1 may recommend a roam to AP 105-2 based on proximity and the anticipated movement of STA 115. In embodiments with multiple neighboring APs, AP 105-1 may assess the potential connectivity improvement of roaming to each neighboring AP, considering the RF environment, the predicted movement pattern, and specific connectivity requirements of STA 115, among others. In some embodiments, AP 105-1 may generate a connectivity improvement score for each neighboring AP. As used herein, the connectivity improvement score indicates the likelihood of improved connectivity if STA 115 roams to a respective neighboring AP.

In some embodiments, the prediction process may be conducted through a ML model, which may utilize a variety of parameters as inputs. In some embodiments, these inputs may include, but are not limited to, signal strength (e.g., RSSI), location data, motion state data, and network load information. Based on the inputs, the ML model may generate the connectivity improvement score for each neighboring AP as an output. In some embodiments, with access to these predictive scores, AP 105-1 may rank the neighboring APs from highest to lowest likelihood of improving connectivity for STA 115. In some embodiments, AP 105-1, based on the results, may recommend the AP with the highest score for STA 115 to roam to. The recommendation may ensure optimal roaming that aligns with the STA's 115 movement patterns and the network's dynamic conditions.

In some embodiments, the ML model to predict the connectivity improvement for each neighboring AP may be trained on historical data sets that include the inputs mentioned above and the outcomes of previous roaming decisions (such as whether roaming to a specific AP improved connectivity as expected). Utilizing techniques such as regression analysis or neural networks, the ML model may learn to correlate specific patterns in the input data with outcomes in terms of connectivity improvement. Then, during interference, the model may apply these learned correlations to new and real-time data to generate accurate predictions about the most beneficial roaming target for STA 115 (and for any other device in the area).

In some embodiments, the predictive analysis results may be transmitted within an 802.11k neighbor report, which includes a list of neighboring APs along with their respective roaming predictions (e.g., connectivity improvement scores), indicating their suitability for roaming based on the connectivity improvement likelihood. In some embodiments, the predictive analysis results may be presented through an 802.11v BSS transition management request, which not only details the neighboring APs (e.g., channels, BSSIDs) and their connectivity improvement predictions as described above, but also recommends to STA 115 the target candidate(s) for roaming (and/or the optimal timing for roaming).

In some embodiments, AP 105-1 may transmit the predictive analysis results and/or roaming recommendations without being asked upon determining that STA 115 is moving away (indicated by situations such as the signal strength falling below a defined threshold) without a prior neighbor report request from STA 115. In some embodiments, STA 115 may proactively send requests, such as an 802.11k neighboring report, a Spectrum Configuration Service (SCS) request, or other relevant service requests to its connected AP. Within these requests, the STA 115 may include the current location and/or motion state data. Upon receiving the request and reported data, AP 105-1 may run its predictive analysis to identify the most beneficial roaming candidate, and sends back the roaming recommendation within an 802.11k neighboring report to STA 115.

In some embodiments, intra-AP roaming may be recommended by the AP 105-1 in view of the location and/or motion state data. For example, when the location and/or motion state data reveal that STA 115 is stationary but RF metrics indicate it is in a sub-optimal coverage area (such as RSSI below a defined threshold or an increase in retry count), intra-AP roaming may be recommended, such as switching the STA 115 from its current frequency band (like 5 GHZ) to another band (like 2.4 GHZ). Such recommendation may ensure that STA 115 maintains the optimal connection by dynamically adjusting to the network's varying capacity and signal quality, even when the device is not moving.

The illustrated example environment 100 depicts only one neighboring AP (e.g., AP 105-2) besides AP 105-1 (with which STA 115 is currently associated). The example environment 100 is provided for conceptual clarity on how the roaming recommendation process is handled in situations where the STA's 115 movement from one AP's coverage area to another. In some embodiments, the environment may include any number of neighboring APs, each potentially offering varying degrees of connectivity quality to STA 115 as it moves. In such configurations, AP 105-1 may evaluate each neighboring AP's potential to select an optimal candidate for roaming.

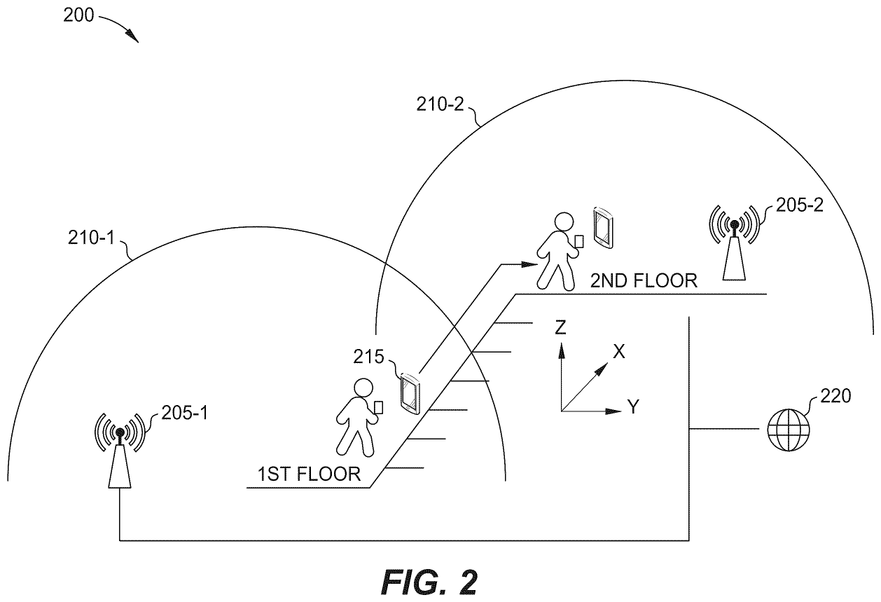

FIG. 2 depicts an example environment 200 where a client device roams across access points (APs) based on vertical movements, according to some embodiments of the present disclosure.

In the illustrated environment 200, two APs 205-1 and 205-2 are connected to the network 220. As illustrated, two APs provide signal coverage for different floors: AP 205-1 provides Wi-Fi signal for 1^{st} floor with coverage area 210-1, and AP 205-2 provides Wi-Fi signal for 2^{nd} floor with coverage area 210-2. The STA 115 is associated with AP 105-1 when the user is on the 1^{st} floor. During or after the association, in some embodiments, AP 205-1 may receive a beacon report from STA 215, listing other APs that STA 215 detected prior to joining the BSS of AP 205-1.

As illustrated, the user is moving vertically from the 1^{st} floor to the 2^{nd} floor, causing the user's device, STA 215, to move away from the coverage area of AP 205-1 towards that of AP 205-2. During the movement, AP 205-1 may detect STA's 215 departure from its coverage based on decreasing signal strength or a degradation in the quality of STA's 215 transmission (e.g., a decrease in the Modulation and Coding Scheme (MCS) value, or an increase in the retry count). Upon detecting these indicators, AP 205-1 may conclude that STA 215 is moving away and proceed to evaluate the need for STA 215 to roam to a better-suited AP for its new location, such as AP 205-2.

As discussed above, the evaluation of STA's 215 need to roam, and/or the prediction of the best neighboring AP to roam to, may be conducted by AP 205-1 by considering not only the RF environment but also STA's 215 location and motion state data (including direction, speed, acceleration, or other metrics that indicate movement patterns). The location and motion state data may be detected by STA 215 using the hardware sensors installed within the device (like a GPS, accelerometer, or compass) or through positioning technologies (like BLE beacons and Wi-Fi-based positioning systems). In some embodiments, STA 215 may send the detected location and/or motion state data to the associated AP 205-1 using a management frame. In some embodiments, STA 215 may augment the data into an 802.11k neighboring report request for the associated AP 205-1.

With access to both the location and motion state data (real-time or historical), as well as data reflecting the RF environment (such as channel utilization, signal strength, and load of each neighboring AP), AP 205-1 may determine with improved accuracy whether roaming is necessary for STA 215. In some embodiments, AP 205-1 may determine roaming is necessary when it receives continuous location updates indicating that STA 215 has a stable presence within the coverage area of AP 205-2, coupled with motion state data showing a transition from rapid vertical movements to minimal movements. All these indicators suggest that the user has reached his or her destination on the 2^{nd} floor. For example, if STA's 215 user moves from the 1^{st} floor to the 2^{nd} floor to attend a meeting, the movement pattern analysis that confirms an extended presence in AP's 205-2 coverage helps AP 205-1 determine that roaming to AP 205-2 is necessary for optimal connectivity during the meeting. In some embodiments, roaming may be considered not useful when STA's 215 location and motion state data show rapid vertical speed and elevator acceleration patterns, which indicate the user is merely passing through the 2^{nd} floor without a stable or extended presence. For example, the STA's 215 user takes an elevator from the 1^{st} floor directly to the 6^{th} floor, briefly passing the 2^{nd} floor. In such a configuration, despite STA 215 entering AP's 205-2 coverage area, roaming is considered not useful or even disruptive, as STA 215 will not remain on the 2^{nd} floor.

In some embodiments, when roaming is considered useful, AP 205-1 may evaluate which neighboring AP would provide the most suitable connectivity experience for STA 215. In the illustrated environment 200, there is only one neighboring AP (e.g., AP 205-2) on the 2^{nd} floor, AP 205-1 may directly recommend a roam to AP 205-2 based on proximity and predicted movement patterns of STA 215. In embodiments where multiple neighboring APs exist on the 2^{nd} floor, AP 205-1 may conduct an evaluation to determine the potential connectivity improvement of roaming to each neighboring AP. A variety of factors may be considered within the evaluation, including but not limited to, the RF environment's characteristics (e.g., signal strength, channel utilization, load or capacity of each AP), STA's 215 location and movement patterns, and its specific connectivity requirements. As discussed in FIG. 1, in some embodiments, when multiple neighboring APs are available, AP 205-1 may utilize a trained ML model to generate a score for each AP, quantifying the likelihood of improved connectivity if STA 215 roams to that AP. By analyzing these scores, AP 205-1 may rank the neighboring APs from highest to lowest based on their potential to enhance STA's 215 connectivity experience, and/or recommend the AP with the highest score as the optimal target for roaming.

In some embodiments, AP 205-1 may send the roaming recommendation to STA 215 without being asked upon detecting that the device is moving away from its coverage area. In some embodiments, AP 205-1 may send the roaming recommendation within a neighbor report in response to a neighbor report request from STA 215.

Although the illustrated example environment 200 that depicts only one neighboring AP (e.g., AP 105-2) on the 2nd floor is provided for conceptual clarity, in some embodiments, the environment may include any number of neighboring APs, each potentially offering varying degrees of connectivity quality to STA 215 as it moves across floors.

The STAs 115 and 215 may also be referred as “client devices,” mobile devices,” or “user devices.” The STAs 115 and 215 may include a wide range of portable electronic devices capable of connecting to a wireless network, including but not limited to, laptops, desktops, tablets, smart phones, industrial sensors, smart watches, smart home devices, and other Internet of Things (IoT) devices.

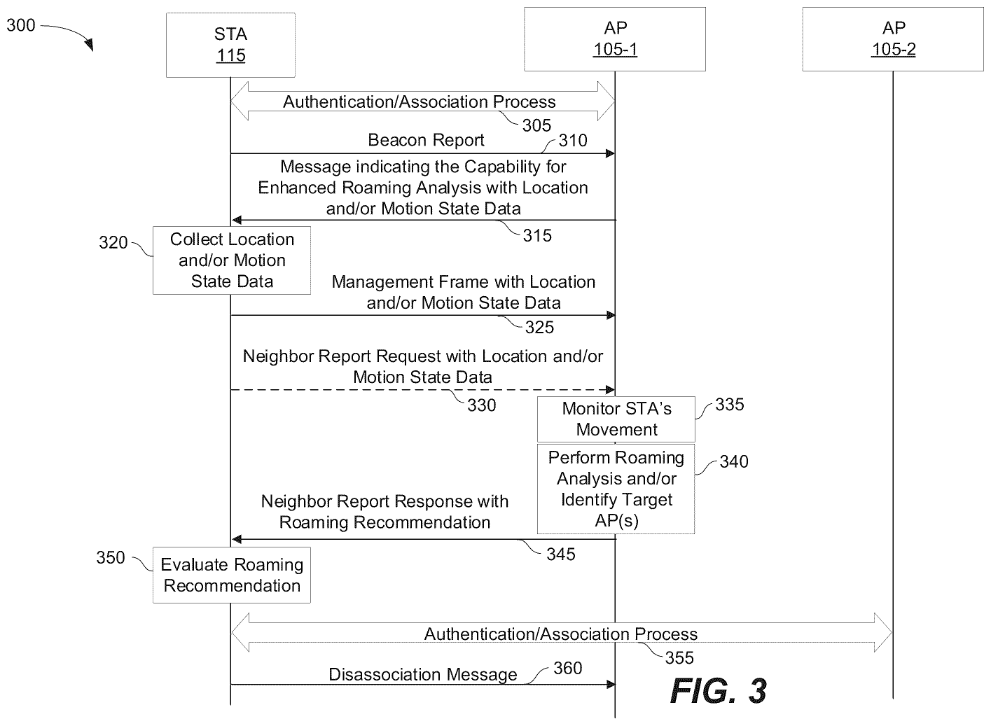

FIG. 3 depicts an example process 300 of roaming optimization with location and motion state data, according to some embodiments of the present disclosure.

In the illustrated example process, AP 105-1 (which may correspond to AP 105-1 as depicted in FIG. 1, and/or AP 205-1 as depicted in FIG. 2) and STA 115 (which may correspond to STA 115 as depicted in FIG. 1, and/or STA 215 as depicted in FIG. 2) establish an association (step 305). This association enables STA 115 to access network connectivity. In some embodiments, the association process may include several steps. First, STA 115 may scan for available APs within its surroundings and identify AP 105-1 and AP 105-2 (which may correspond to AP 105-2 as depicted in FIG. 1, and/or AP 205-2 as depicted in FIG. 2) as available APs. STA 115 may then select AP 105-1 over AP 105-2 based on criteria like network security and/or signal strength. For example, STA 115 may determine that the signal from AP 105-1 is stronger and/or more stable than that from AP 105-2. Following the selection, STA 115 may then go through an authentication process with AP 105-1. For example, STA 115 may utilize the network security protocols to verify its eligibility to join the BSS of AP 105-1. Following the authentication, STA 115 may then send an association request to AP 105-1. AP 105-1 may respond with an association response upon approval. With the reception of the association response, STA 115 may now be associated with AP 105-1 and connected to the network.

During or after the association, STA 115 sends an 802.11k beacon report to AP 105-1 (step 310). The report may include details about the neighboring APs that STA 115 heard before joining the BSS of AP 105-1, such as their SSIDs, signal strengths, and channel utilization. With the beacon report from STA 115, AP 105-1 understands the current network environment with improved accuracy. In some embodiments, AP 105-1 may provide information about the neighboring APs to a ML engine. The ML engine, based on the data, may predict the approximate position of STA 115, either in the form of a quadrant or a more accurate position value.

During or after the association, AP 105 sends a message to STA 115, indicating its capability to provide more accurate roaming recommendations if it receives STA's 115 location and/or motion state data (step 315). In some embodiments, the message may be included in a specific frame, such as a management frame for more detailed network management and/or client device communications. In some embodiments, the message may be included as a simple bit set in an information element (IE) that is part of standard communication protocols between APs and client devices, such as beacon frames or probe responses. By sending the message, AP 105-1 informs STA 115 that it can utilize additional data (like location and/or motion state information) to optimize the roaming decision process.

Upon learning of AP's 105-1 capacity to utilize additional data for optimized roaming recommendations, STA 115 proceeds to collect and send its location and/or motion state data to AP 105-1 (step 320). In some embodiments, the location data reported may detail the device's precise or approximate geographic location, determined through various methods. In some embodiments, the location may be detected by the STA 115's hardware sensors, such as GPS, which can provide precise location data. In some embodiments, such as when the STA is located indoors (where the GPS signal is weak or unavailable), STA 115 may identify its location through the use of BLE beacons. The emit signals from a beacon may be used to locate its position within a structure. In some embodiments, STA 115 may use the 802.11az protocol (also known as Next Generation Position (NGP)) to determine its location relative to the associated AP by measuring the time of flight of Wi-Fi signals.

In some embodiments, STA 115 may return an approximate location with less accuracy under certain conditions, such as when it cannot establish its location with high precision due to weak GPS or indoor positioning signals, or when policy restrictions prevent it from sharing precise location data. In such configurations, the approximate location may be determined by analyzing the RSSI values detected by STA 115 from the top “N” APs it has detected. AP 105-1 may then use this information to predict the STA 115's likely position within its coverage area. For example, by analyzing the RSSI values from multiple APs, AP 105-1 may use triangulation or other positioning algorithms to determine a likely location for STA 115.

In some embodiments, STA 115 may engage in a Fine Timing Measurement (FTM) exchange with AP 105-1 (and possibly other nearby APs) to estimate its location. The process may involve sending and receiving precise timing measurements that allow for the calculation of the distance between STA 115 and AP 105-1 (and possibly other APs) based on the time it takes for signals to travel between them. Following the FTM exchange, STA 115 may return the Location Measurement Report (LMR) feedback to AP 105-1. Based on the LMR feedback, which includes the measured distance to AP 105-1 (and possible other APs), AP 105-1 may estimate the approximate location of STA 115.

In some embodiments, the location data obtained through these measurement techniques may be encapsulated within the Location Configuration Information (LCI) Information Element (IE), as described in 802.11-2020, following the RFC 6225 format.

The motion data collected and shared by STA 115 may include a variety of metrics that reflect the device's movement patterns. These metrics may include, but are not limited to, direction, speed, acceleration, and/or movement path (such as whether the device is moving in a straight line or following a more complex path). These metrics may be determined using one or more sensors within the STA 115. For example, a compass sensor may be used to detect the STA's 115 direction of travel, and an accelerometer may be used to measure the rate of change in velocity (also known as the acceleration). In some embodiments, the speed of travel may be calculated based on the change in location over a unit of time.

In some embodiments, STA 115 may use a vector to indicate its direction of movement. The vector may represent the device's movement in three dimensions (3D): longitude (x), latitude (y), and altitude (z). The vector may indicate the device's speed by capturing the changes in these coordinates per unit of time. In some embodiments, the 3D vector is normalized to unit length, with an additional value that indicates the unit of time over which the observed changes occur. For example, a vector representation of {0.66, 0.47, 0.57; 2.5} may represent a normalized vector corresponding to the direction {8, 6, 7} with a displacement occurring every 2.5 seconds. In some embodiments, the vector may not be normalized and directly represent the observed displacement per second. In such a configuration, the vector itself presents both the direction and magnitude of movement, making a separate time value unnecessary. For example, a vector {5, 4, 3.5} directly indicates the change in longitude, latitude, and altitude, respectively, per second. In some embodiments, the 3D vector may represent acceleration in the longitude, latitude, and altitude (e.g., x, y and z axes). Such a vector may provide insights into how quickly the direction and speed of STA 115's movement are changing over time. For example, an acceleration vector like {0.1, 0.2, −0.01} may represent the acceleration rate (also known as the rate of change in velocity) along each axis per unit of time.

With the location and/or motion state data collected, STA 115 may report the information to AP 115-1 using a management frame (step 325). The reporting may occur periodically, to ensure continuous monitoring of STA's 115 position and movement, or it may be event-triggered, activated by specific conditions (such as the RSSI falling below a defined threshold) that indicate a potential connectivity issue or the imminent need for roaming. Upon receiving the data, AP 105-1 may store it for future analysis, such as using it to refine its roaming recommendations.

In some embodiments, STA 115 may augment the location and/or motion state data into a neighbor report request sent to AP 105-1 (step 330). STA 115 may send the request when it considers roaming as a potential action.

AP 105-1 actively monitors movements of STA 115 through the received location and/or motion state data, along with RF metrics it scans from the wireless environment (step 335). The AP 105-2 may conclude that STA 115 is moving away from its coverage area based on several indicators, including a decrease in signal strength between STA 115 and AP 105-1 (evidenced by a decrease in the RSSI values), a degradation in quality of transmission (evidenced by a decrease in MCS values or an increase in retry count), or even a predicted movement path moving out of AP's 105-1 coverage area (based on the location and/or motion state data).

Upon reaching the conclusion, AP 105-1 initiates an analysis for roaming prediction (step 340). The analysis may involve determining whether roaming is (or may be) useful for STA 115 and if so, identifying which neighboring AP can provide the optimal connectivity experience as STA 115 moves. The prediction process may consider a combination of factors, including but not limited to, the RF environment, the predicted movement patterns of the device, and the compatibility of network services between the device and other available APs. To facilitate these roaming predictions, ML models that incorporate both historical and real-time data may be used. In embodiments where multiple neighboring APs exist, each with signal strength above a defined threshold, the ML model may generate a score for each AP, indicating the likelihood of connectivity improvement for STA 115 if it roams to that AP. Relying on the scoring system, AP 105-1 may rank the neighboring APs based on their potential to enhance STA's 115 network connectivity, and/or recommend the best AP for roaming.

In the illustrated process, AP 105-1 communicates the predictive analysis result to STA 115 (step 345). In some embodiments, AP 105-1 may incorporate the results within a neighbor report, which includes a list of neighboring APs and their respective connectivity improvement predictions (e.g., a score), indicating their suitability for roaming based on the predictions. Through the report, STA 115 may make an informed decision on whether and when to initiate roaming, and identify the target AP for roaming (e.g., the neighboring AP that provides optimal connectivity as STA 115 moves).

In some embodiments, AP 105-1 may include the results within a BSS transition management request. Besides listing the neighboring APS and their roaming predictions, the request explicitly recommends one or more candidates for roaming. In some embodiments, the request may further suggest an optimal timing for roaming, which helps STA 115 to smoothly switch to a better AP without disrupting ongoing activities and/or data transmission.

With the reception of the roaming recommendations from AP 105-1, STA 115 evaluates the recommendations to make an informed roaming decision (step 350). In some embodiments, STA 115 may verify whether the security protocols of the recommended AP, like AP 105-2, match its security requirements. Such verification is to ensure that the connection will be secure and that STA 115 is capable of authenticating with the new AP. In some embodiments, the STA 115 may check for compatibility of network services between itself and the recommended AP, like AP 105-2. For example, the network services may include support for specific applications that are important to the STA's 115 user. The compatibility check is to ascertain that primary functionalities remain accessible post-roaming. Additionally, in some embodiments, such as when information about the network load of the recommended AP is provided in the neighbor report, STA 115 may assess it to check if the recommended AP is overly congested. Roaming to a less congested AP would be preferred for improved performance and lower latency. After a thorough evaluation of these factors, STA 115 may decide whether to proceed with the roaming recommendation. If STA 115 decides to switch to the new AP, like AP 105-2, it initiates the association process with the new AP (step 355).

In some embodiments, the association process may follow several steps. First, STA 115 may send an authentication request to AP 105-2, following the security protocols previously verified as compatible. Upon successfully authenticating STA 115, AP 105-2 may send an association response to the device that adds STA 115 to its network.

After STA 115 switches to AP 105-2 and/or completes the roaming process (that any necessary updates to STA's network settings have been completed to facilitate effective commutation through its new AP), it may optionally send a message to AP 105-1, informing it of the disassociation (step 360). The disassociation message may help AP 105-2 to manage its network resources more effectively, such as reallocating the bandwidth and other resources previously reserved for STA 115 to another associated device.

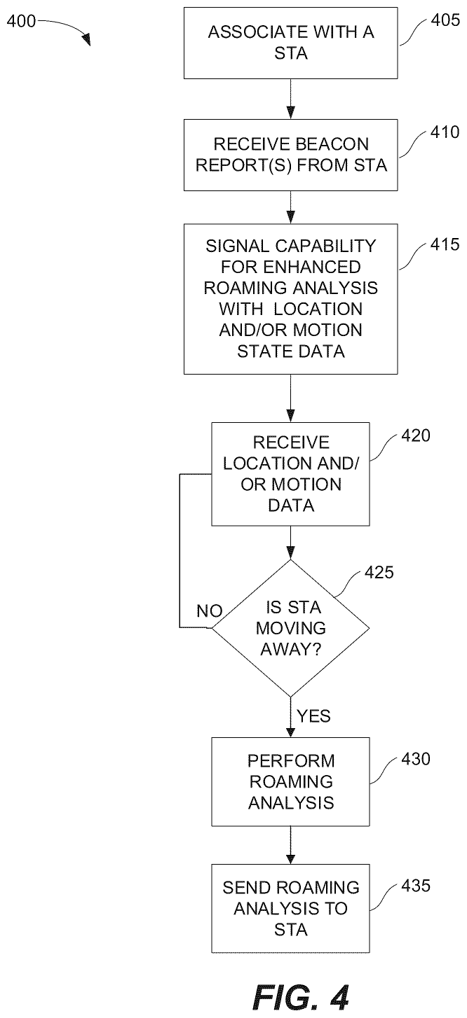

FIG. 4 depicts an example method 400 of an AP optimizing roaming recommendations for its associated client device based on location and motion state data, according to some embodiments of the present disclosure. In some embodiments, the method 400 may be performed by one or more APs, such as APs 105-1 and 105-2 as depicted in FIGS. 1 and 3, and APs 205-1 and 205-2 as depicted in FIG. 2. In some embodiments, the method 400 may be performed by one or more other network devices that possess the required capabilities for dynamic network management, such as wireless controllers (WLCs), routers, network switches, and the like.

The method 400 begins at block 405, where an AP (e.g., AP 105-1 of FIG. 1) establishes a connection with a client device (also referred to as a STA) (e.g., STA 115 of FIG. 1), as it enters the coverage area (e.g., 110-1 of FIG. 1). This association process may include several steps to make a secure and efficient network connection. In some embodiments, as the STA moves within range, it may initiate scanning for available Wi-Fi networks. In response, the AP may broadcast its presence through beacon frames or answer probe requests from the STA. These signals may contain information about the AP, including its SSID or the security protocols it supports. Upon identifying the AP as a preferred network, the STA may send an authentication request to confirm its eligibility to access the network. The AP may then evaluate the request and, upon verification of the STA's credentials, respond with approval. Following that, the STA may proceed to send an association request to the AP, indicating its capabilities (e.g., supported data rates and Wi-Fi standards). The AP may review the request and, upon determining that the STA meets the network policies and standards, send back an association response to the STA. The response indicates that the STA has been added to the AP's network.

After or during the association, at block 410, the AP receives beacon report(s) from the STA. In some embodiments, the report may include a list of other APs that the STA has detected in its vicinity, along with their SSIDs and signal strengths. The report may allow the AP to learn about the local RF environment as detected by the STA.

At block 415, the AP signals its capability of making more accurate roaming predictions when it has access to the STA's location and movement information. To communicate this capability to the STA, in some embodiments, the AP may send a specific frame to the STA. The frame may indicate the AP's ability to utilize location and/or motion state data for optimized roaming analysis. In some embodiments, the AP may indicate this capability through a simple bit set in an IE within standard communication protocols, such as beacon frames or probe responses. Upon learning the AP's capabilities for optimized roaming analysis, the STA may begin collecting its location and/or motion state data. In some embodiments, the STA may use its built-in hardware sensors to gather the data, such as using GPS for location tracking, a compass for direction, and an accelerometer for velocity changes. In some embodiments, in addition to or instead of using hardware sensors, the STA may use communication protocols to gather the necessary data. For example, in some embodiments, the STA may use BLE beacons to estimate its position within a building. In some embodiments, the STA may use NGP messages to estimate its relative location to an AP based on the measured time of flight. After collecting the location and/or motion state data, the STA may send it directly to the AP using a management frame. In some embodiments, the STA may incorporate the data into a neighbor report request, providing the device's observed RF environment and the location and/or motion state data to the associated AP.

At block 420, the AP receives the location and/or motion state data from the STA. In some embodiments, the data reporting may occur periodically or event-triggered. The AP may store the received data in storage for future roaming analysis.

At block 425, the AP monitors the STA's status to determine whether it is moving away from its coverage area, suggesting that potential roaming may be beneficial for maintain the optimal connectivity. In some embodiments, the monitoring process may involve examining the signal strength (e.g., RSSI values) between the AP and the STA. When the signal strength falls below a predefined threshold, it may indicate that the STA is moving out of the coverage area of the AP, and that the STA may potentially benefit from roaming to a new AP to maintain optimal connectivity and/or user experience. If such a decrease in signal strength is observed, the method 400 proceeds to block 430, where the AP initiates the roaming prediction process. If the signal strength remains equal to or above the threshold, the method 400 returns to block 420, where the AP continues to receive the reported location and/or motion state data. In some embodiments, the monitoring process may include the analysis of the STA's movement path (predicted based on the received location and/or motion data). This approach may allow the AP to anticipate the STA's exit from its coverage area before a significant drop in signal strength. In some embodiments, the AP may further assess the quality of the transmission between itself and the STA by monitoring indicators such as an increase in the retry count or a decrease in the MCS value, which can further suggest that the STA is moving to an area where the current AP can no longer provide the best service. Upon reaching the conclusion that the STA is moving away from the AP's coverage area (indicated by a decrease in signal strength, a predicted movement path leading away from the AP, or an observed degradation in transmission quality), the method 400 proceeds to block 430.

At block 430, the AP initiates a roaming analysis to determine whether roaming is useful for the STA and if so, identify which neighboring AP the STA should roam to for optimal connectivity. In some embodiments, the analysis may also involve a prediction of when the STA should make such a roam to maintain optimal network connectivity. In the roaming analysis, a variety of data may be considered to optimize the STA's connectivity experience. The data may include the RF environment's characteristics (such as signal strength, network load, and channel utilization of each AP within the environment), the STA's location data, the STA's motion state data (such as direction of movement, speed, and acceleration, or even moving paths), and the STA's connectivity requirements (such as requirements for bandwidth, latency, and reliability).

As discussed in FIGS. 1 and 2, roaming may be considered useful if it is detected that the STA is moving directly away from the AP at a high speed, suggesting an imminent exit from the signal coverage area. In contrast, roaming may be considered not useful if the STA's moving speed is low, the device's movement remains within a confined area, or a loop path is detected based on historical motion and location data, which indicates that the STA is likely to stay within or return to the AP's coverage.

When vertical movements across floors is involved, roaming may be considered useful upon detecting a consistent movement across floors coupled with an extended presence on a new floor, indicating that the STA has transitioned to an area better serviced by another AP. Roaming may be considered not useful when rapid vertical speed and elevator acceleration patterns are detected, suggesting that the STA is merely passing through a floor without stopping.

In some embodiments, the determination of necessity or usefulness for roaming may involve running a ML model that has been trained on historical datasets concerning device movements, connectivity quality, and network performance. The ML model may analyze current conditions in real-time, comparing them against learned patterns to predict whether the STA will benefit from roaming to maintain (or improve) its network connection.

Upon determining that roaming is necessary or useful and identifying the environment as having multiple potential candidates (e.g., APs with signal strength over a defined threshold), in some embodiments, further analysis may be conducted to compare these APs based on their potentials (or likelihoods) to improve connectivity if the STA were to roam one of them. APs located on the path of the STA's movement may be more likely to offer stable connectivity than those that do not align with the path. A ML model may be used to predict the likelihood of connectivity improvement with each neighboring AP, and/or generate a score for each AP. These scores may include various factors, including but not limited to signal strength, network load, compatibility of services, and the predicted movement of the STA. By analyzing these scores, the AP may rank the neighboring APs from highest to lowest in terms of their potential to provide an improved connectivity experience for the STA. Based on the ranked list, the AP may select the top one or more APs as the recommended candidates for the STA to roam to.

In some embodiments, the roaming analysis may further include intra-AP roaming from one frequency band to another. When location and/or motion state data indicate that the STA is stationary, but RF metrics reveal a decrease in signal strength or quality of transmission, these indicators suggest that the current frequency band (like 5 GHz) in use by the STA may be experiencing congestion or interference, and therefore is providing the optimal connections for the device activity. In such configurations, intra-AP roaming that switches the STA from its current band to another may be considered to ensure high-quality data transmissions.

At block 435, the AP communicates the results of the roaming analysis (or recommendation) to the STA. In some embodiments, the AP may include the predictive results within a neighbor report, which details the neighboring APs and their respective likelihoods for connectivity improvement. In some embodiments, the neighbor report may be sent by the AP without being asked upon detecting that the STA is moving away from the coverage. In some embodiments, the AP may send the neighbor report in response to a neighbor report request from the STA, where the STA has already identified a potential need for better connectivity and is seeking information on available networks. In some embodiments, the results of the roaming analysis may be included within a BSS transition management request. The request may not only list the APs and their connectivity improvement predictions, but also recommend the target AP(s) for the STA to roam (and/or the optimal timing for such a roam).

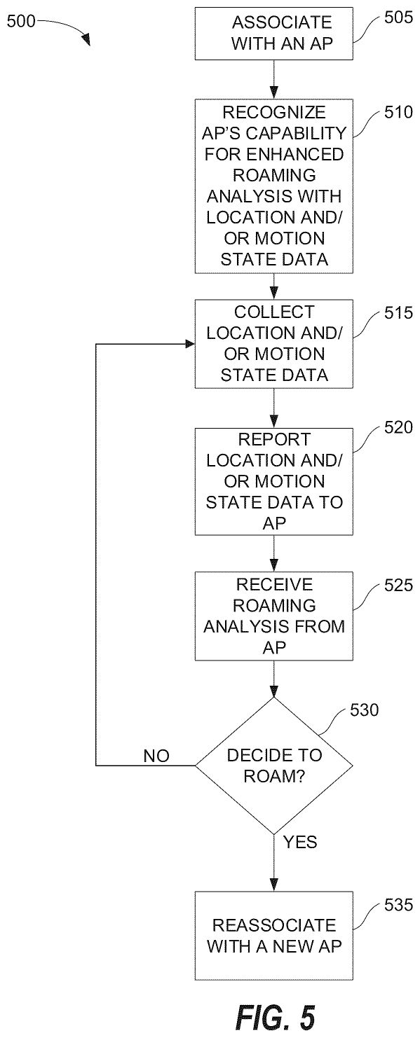

FIG. 5 depicts an example method 500 of a client device collecting location and motion state data and engaging with its associated AP to optimize roaming decisions, according to some embodiments of the present disclosure. In some embodiments, the method 500 may be performed by one or more STAs, such as STA 115 as depicted in FIGS. 1 and 3, and STA 215 as depicted in FIG. 2.

At block 505, a STA (e.g., STA 115 of FIG. 1) establishes a connection with an AP (e.g., AP 105-1 of FIG. 1), as it enters the AP's coverage area.

At block 510, the STA receives a message from the AP, indicating the AP's capability to perform enhanced roaming analysis with the STA's location and/or motion state data. The message may be a management frame or a probe response that includes an IE detailing the AP's capacity. The message informs the STA that the AP can use additional data for a more accurate roaming analysis.

At block 515, the STA collects location and/or motion state data using built-in hardware sensors (e.g., GPS, compass, accelerometer) or through protocol exchange messages (e.g., BLE beacons, NGP protocols, FTM exchanges).

At block 520, the STA reports the collected location and/or motion state data to the AP. The reporting may be periodic or event-triggered. The data may be sent through a management frame or by being augmented into a neighbor report request, depending on the network protocols and the STA's capabilities.

At block 525, the STA receives the predictive results from the AP. The information may include a list of potential APs for roaming and their respective connectivity improvement predictions. In some embodiments, the information may also include the AP's recommendations on whether to roam and, if so, where and when to roam for optimal connectivity.

At block 530, the STA evaluates the roaming analysis results and/or the recommendations provided by the AP. In some embodiments, the evaluation may include verifying the security protocols of the recommended AP(s), checking for compatibility within network services, and assessing the network load to avoid overly congested situations. Based on the evaluation, the STA decides whether to proceed with the roaming recommendation. If the STA decides to roam to another AP, the method 500 moves to block 535. If the STA decides against roaming (that the STA maintains its current association), the method 500 returns to block 515, where the STA continues to monitor the RF environment, and/or collect its location and movement data.

At block 535, the STA initiates the association process with the new AP (e.g., AP 105-2 of FIG. 2). The STA may complete the necessary authentication and association steps to establish connectivity with the new network.

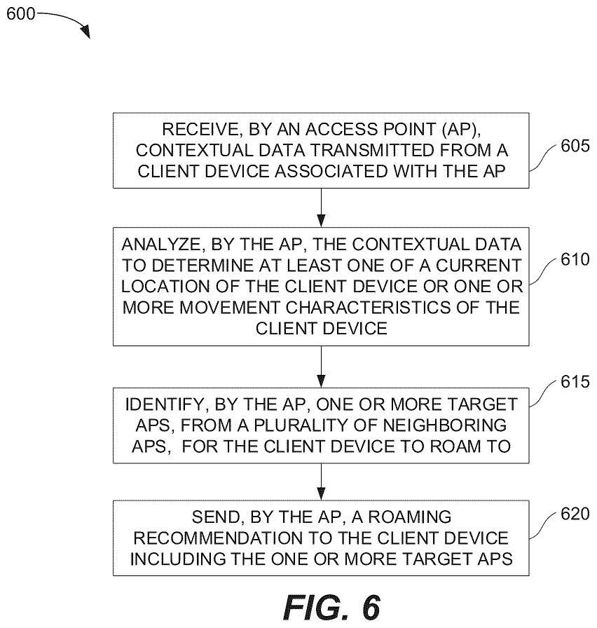

FIG. 6 is a flow diagram depicting an example method for optimizing roaming strategies with location and motion state data, according to some embodiments of the present disclosure.

At block 605, an AP (e.g., AP 105-1 of FIG. 1) receives contextual data transmitted from a client device (e.g., STA 115 of FIG. 1) associated with the AP. In some embodiments, the contextual data transmitted from the client device may comprise at least one of location data representing the current location of the client device, or motion state data representing the one or more movement characteristics of the client device.

At block 610, the AP analyzes the contextual data to determine at least one of a current location of the client device or one or more movement characteristics of the client device.

At block 615, the AP identifies one or more target APs (e.g., AP 105-2 of FIG. 1), from a plurality of neighboring APs, for the client device to roam to.

In some embodiments, the process of identifying the one or more target APs may comprise processing at least one of the current location of the client device or the one or more movement characteristics of the client device as input data for a machine learning (ML) model, predicting, using the ML model, a connectivity improvement score for each of the plurality of neighboring APs, wherein the connectivity improvement score represents a likelihood of improved connectivity if the client device is roamed to a respective neighboring AP, and selecting the one or more target APs from the plurality of neighboring APs based on a determination that the connectivity improvement scores for the one or more target APs exceed a defined threshold.

In some embodiments, the defined threshold for selecting the one or more target APs may be adjustable based at least in part on network policies, desired quality of service levels, or network conditions.

At block 620, the AP sends a roaming recommendation to the client device including the one or more target APs.

In some embodiments, the AP may further assess one or more network conditions relevant to a roaming decision of the client device. In some embodiments, the one or more network conditions may comprise at least one of a signal strength of each neighboring AP, a network load of each neighboring AP, or a channel utilization of each neighboring AP.

In some embodiments, the roaming recommendation may be sent by the AP upon detecting that a signal strength between the AP and the client device falls below a defined signal strength threshold, indicating a deterioration in network connectivity for the client device. In some embodiments, the recommendation may be sent by the AP upon receiving a request from the client device.

In some embodiments, the AP may further transmit a message to the client device, wherein the message indicates that the AP is capable of providing a roaming recommendation based on the contextual data. In some embodiments, the message may comprise at least one of a management frame or a bit set within an information element that is part of a beacon frame or a probe response

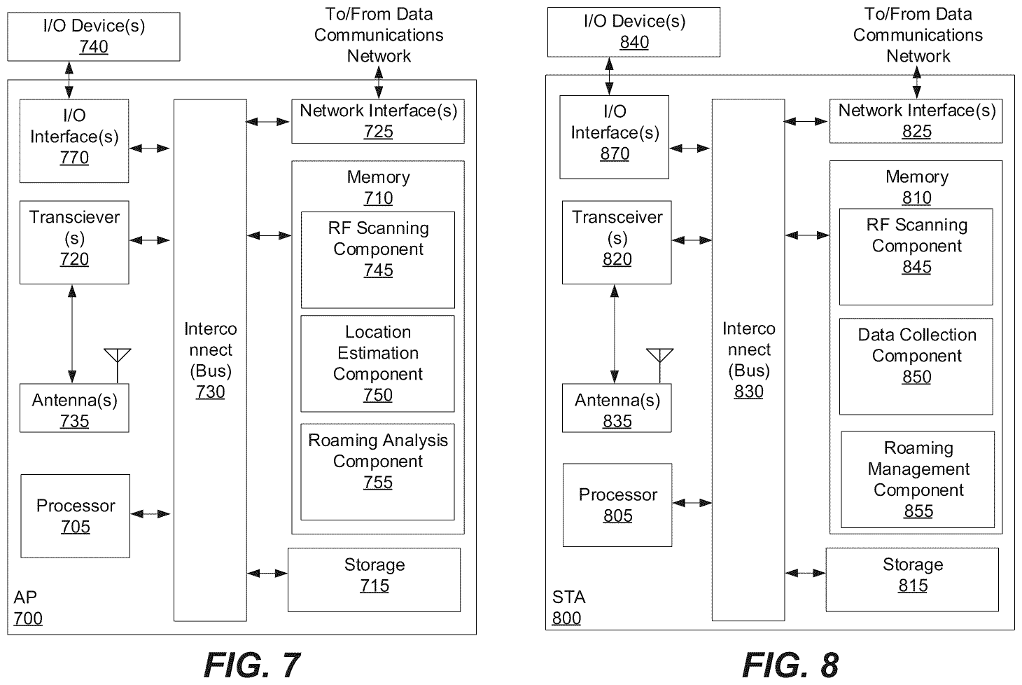

FIG. 7 depicts an example AP 700 supporting roaming optimization based on location and motion state data, according to some embodiments of the present disclosure. In some embodiments, the example AP 700 may correspond to the APs 105 as depicted in FIGS. 1 and 3, and the APs 205 as depicted in FIG. 2.

As illustrated, the example AP 700 includes a processor 705, memory 710, storage 715, one or more transceivers 720, one or more I/O interfaces 770, and one or more network interfaces 725. In some embodiments, I/O devices 740 are connected via the I/O interface(s) 770. Further, via the network interface 725, the AP 700 can be communicatively coupled with one or more other devices and components (e.g., via a network, which may include the Internet, local network(s), and the like). Each of the components is communicatively coupled by one or more buses 730. In some embodiments, one or more antennas 735 may be coupled to the transceivers 720 for transmitting and receiving wireless signals.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 720, I/O interfaces 770, and the network interfaces 725. The processor 705 retrieves and executes programming instructions stored in memory 710, as well as stores and retrieves application data residing in storage 715.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 815 may store a variety of data for the efficient functioning of the system.

The memory 710 may include random access memory (RAM) and read-only memory (ROM). The memory 710 may store processor-executable software code containing instructions that, when executed by the processor 705, enable the AP 700 to perform various functions described herein for wireless communication. In the illustrated example, the memory 710 includes three software components: the RF scanning component 745, the location estimation component 750, and the roaming analysis component 755. In some embodiments, the RF scanning component 745 may be configured to scan the RF environment around the example AP. The component 745 may scan for signals from other APs and devices within its range, assessing their signal strengths, channel utilization, and interference levels. The data obtained during the scanning process may then be used to evaluate network conditions and/or conduct roaming analysis. In some embodiments, the location estimation component 750 may be configured to analyze data to determine the approximate location of a connected device (like STA 115 in FIG. 1). Utilizing information from the connected device, such as signal strength measurements, timing information from protocols like FTM, or data from other positioning technologies (e.g., BLE beacons, NGP), the component 750 may estimate the device's approximate location. The location data may then be used to identify the device's movement patterns, improving the accuracy and efficiency of the example AP's roaming analysis. In some embodiments, the roaming analysis component 755 may evaluate the need of the connected device to roam to another AP for better connectivity. The component 755 may use inputs from the RF scanning component 745 and/or the location estimation component 750 to analyze the device's current network conditions and/or movement patterns. Considering a wide range of factors, such as signal strength trends, network load, the device's location and moving characteristics, and the performance of neighboring APs, the component 755 may predict when the device should roam and to which AP. The component 755 may send the roaming analysis and recommendations to the connected device.

Although depicted as a discrete component for conceptual clarity, in some embodiments, the operations of the depicted components (and others not illustrated) may be combined or distributed across any number of components. Further, although depicted as software residing in memory 710, in some aspects, the operations of the depicted components (and others not illustrated) may be implemented using hardware, software, or a combination of hardware and software.

FIG. 8 depicts an example client device 800 supporting location and motion state data collection and roaming optimization, according to some embodiments of the present disclosure. In some embodiments, the example client device 800 may correspond to the STA 115 as depicted in FIGS. 1 and 3, and the STA 215 as depicted in FIG. 2.

As illustrated, the client device 800 includes a processor 805, memory 810, storage 815, one or more transceivers 820, one or more I/O interfaces 870, and one or more network interfaces 825. In some embodiments, I/O devices 840 are connected via the I/O interface(s) 870. Further, via the network interface 825, the client device 800 can be communicatively coupled with one or more other devices and components (e.g., via a network, which may include the Internet, local network(s), and the like). Each of the components is communicatively coupled by one or more buses 830. In some embodiments, one or more antennas 835 may be coupled to the transceivers 820 for transmitting and receiving wireless signals.

The processor 805 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 805 processes information received through the transceiver 820, I/O interfaces 870, and the network interfaces 825. The processor 805 retrieves and executes programming instructions stored in memory 810, as well as stores and retrieves application data residing in storage 815.

The storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 815 may store a variety of data for the efficient functioning of the system.

The memory 810 may include random access memory (RAM) and read-only memory (ROM). The memory 810 may store processor-executable software code containing instructions that, when executed by the processor 805, enable the device 800 to perform various functions described herein for wireless communication. In the illustrated example, the memory 810 includes three software components: the RF scanning component 845, the data collection component 850, and the roaming management component 855. In some embodiments, the RF scanning component 845 may be configured to scan the RF environment for available APs. The component 845 may identify each AP's network identifier (e.g., SSID) and supported security protocols, and assess each AP's signal strength. In some embodiments, the data collection component 850 may gather location and/or motion state data of the example device 800. The component 850 may use the device's built-in sensors or external positioning system (e.g., GPS, BLE beacons, Wi-Fi positioning) for data collection. The data the component 850 collects may include the device's geographical position, direction of travel, speed, acceleration, and any other metrics that reflect the device's movement patterns. The component 850 may then report the data to the associated AP (e.g., AP 700 of FIG. 7) for further roaming analysis, which involves determining whether roaming is necessary and, if so, identifying the timing and target AP(s) for the device to roam to for improved network connectivity. In some embodiments, the roaming management component 855 may be configured to evaluate the roaming recommendations received from the associated AP to decide whether to initiate a roaming process. The evaluation may consider various factors, including the recommended AP's signal strength, network load, and compatibility with the device's requirements. If the decision is made to roam, the component 855 may manage the disassociation from the current AP and reassociation with the new AP.

Although depicted as a discrete component for conceptual clarity, in some embodiments, the operations of the depicted components (and others not illustrated) may be combined or distributed across any number of components. Further, although depicted as software residing in memory 810, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, by an access point (AP), contextual data transmitted from a client device associated with the AP;
analyzing, by the AP, the contextual data to determine at least one of a current location of the client device or one or more movement characteristics of the client device;
identifying, by the AP, one or more target APs, from a plurality of neighboring APs, for the client device to roam to; and
sending, by the AP, a roaming recommendation to the client device including the one or more target APs.

2. The method of claim 1, wherein the contextual data transmitted from the client device comprises at least one of location data representing the current location of the client device, or motion state data representing the one or more movement characteristics of the client device.

3. The method of claim 1, further comprising assessing, by the AP, one or more network conditions relevant to a roaming decision of the client device.

4. The method of claim 3, wherein the one or more network conditions comprise at least one of a signal strength of each neighboring AP, a network load of each neighboring AP, or a channel utilization of each neighboring AP.

5. The method of claim 1, wherein identifying, by the AP, the one or more target APs, from the plurality of neighboring APs, for the client device to roam to comprises:
processing at least one of the current location of the client device or the one or more movement characteristics of the client device as input data for a machine learning (ML) model;
predicting, using the ML model, a connectivity improvement score for each of the plurality of neighboring APs, wherein the connectivity improvement score represents a likelihood of improved connectivity if the client device is roamed to a respective neighboring AP; and
selecting the one or more target APs from the plurality of neighboring APs based on a determination that the connectivity improvement scores for the one or more target APs exceed a defined threshold.

6. The method of claim 5, wherein the defined threshold for selecting the one or more target APs is adjustable based at least in part on network policies, desired quality of service levels, or network conditions.

7. The method of claim 1, wherein the roaming recommendation is sent by the AP upon detecting that a signal strength between the AP and the client device falls below a defined signal strength threshold, indicating a deterioration in network connectivity for the client device.

8. The method of claim 1, wherein the recommendation is sent by the AP upon receiving a request from the client device.

9. The method of claim 1, further comprising transmitting, by the AP, a message to the client device, wherein the message indicates that the AP is capable of providing a roaming recommendation based on the contextual data.

10. The method of claim 9, wherein the message comprises at least one of a management frame or a bit set within an information element that is part of a beacon frame or a probe response.

11. A system comprising:
one or more computer processors; and
one or more memories collectively containing one or more programs, which, when executed by the one or more computer processors, perform operations, the operations comprising:
receiving, by an access point (AP), contextual data transmitted from a client device associated with the AP;
analyzing, by the AP, the contextual data to determine at least one of a current location of the client device or one or more movement characteristics of the client device;
identifying, by the AP, one or more target APs, from a plurality of neighboring APs, for the client device to roam to; and
sending, by the AP, a roaming recommendation to the client device including the one or more target APs.

12. The system of claim 11, wherein the contextual data transmitted from the client device comprises at least one of location data representing the current location of the client device, or motion state data representing the one or more movement characteristics of the client device.

13. The system of claim 11, wherein the one or more programs, which, when executed by the one or more computer processors, perform the operations further comprising assessing, by the AP, one or more network conditions relevant to a roaming decision of the client device.

14. The system of claim 13, wherein the one or more network conditions comprise at least one of a signal strength of each neighboring AP, a network load of each neighboring AP, or a channel utilization of each neighboring AP.

15. The system of claim 11, wherein, to identify, by the AP, the one or more target APs, from the plurality of neighboring APs, for the client device to roam to, the one or more programs, which, when executed by the one or more computer processors, perform the operations comprising:
processing at least one of the current location of the client device or the one or more movement characteristics of the client device as input data for a machine learning (ML) model;
predicting, using the ML model, a connectivity improvement score for each of the plurality of neighboring APs, wherein the connectivity improvement score represents a likelihood of improved connectivity if the client device is roamed to a respective neighboring AP; and
selecting the one or more target APs from the plurality of neighboring APs based on a determination that the connectivity improvement scores for the one or more target APs exceed a defined threshold.

16. The system of claim 15, wherein the defined threshold for selecting the one or more target APs is adjustable based at least in part on network policies, desired quality of service levels, or network conditions.

17. The system of claim 11, wherein the roaming recommendation is sent by the AP upon detecting that a signal strength between the AP and the client device falls below a defined signal strength threshold, indicating a deterioration in network connectivity for the client device.

18. The system of claim 11, wherein the recommendation is sent by the AP upon receiving a request from the client device.

19. The system of claim 11, wherein the one or more programs, which, when executed by the one or more computer processors, perform the operations further comprising transmitting, by the AP, a message to the client device, wherein the message indicates that the AP is capable of providing a roaming recommendation based on the contextual data.

20. One or more non-transitory computer-readable media containing, in any combination, computer program code, which, when executed by a computer system, performs operations comprising:
receiving, by an access point (AP), contextual data transmitted from a client device associated with the AP;
analyzing, by the AP, the contextual data to determine at least one of a current location of the client device or one or more movement characteristics of the client device;
identifying, by the AP, one or more target APs, from a plurality of neighboring APs, for the client device to roam to; and
sending, by the AP, a roaming recommendation to the client device including the one or more target APs.
